(19) United States
(12) Patent Application Publication
(10) Pub. No.: US 2016/0002021 A1
(43) Pub. Date: Jan. 7, 2016

(54) WATER DISPENSER

(71) Applicant: KABUSHIKI KAISHA COSMO LIFE, Kakogawa-shi, Hyogo (JP)

(72) Inventor: Yoshinori ORITA, Hyogo (JP)

(21) Appl. No.: 14/772,107

(22) PCT Filed: Dec. 6, 2013
(86) PCT No.: PCT/JP2013/082808

§ 371 Date: Sep. 2, 2015

(30) Foreign Application Priority Data
Mar. 4, 2013 (JP) 2013-041512

(51) Int. Cl. B67D 3/00

(52) U.S. Cl. CPC B67D 3/0038; B67D 3/0022

(57) ABSTRACT

In a water dispenser, drinking water is introduced into a hot water tank through a hot water tank water supply pipe from an upper tank arranged at a higher level than the hot water tank. This water dispenser includes a hot water discharge pipe through which high-temperature drinking water is discharged to outside from the hot water tank and which has an end portion on the side of the hot water tank, the end portion having an opening at a position spaced apart downwardly from the top surface of the hot water tank. The hot water tank water supply pipe includes an in-tank pipe portion formed with a small hole located at a higher level than the opening of the end portion.

### TECHNICAL FIELD

The present invention relates to a water dispenser in which drinking water is supplied from a replaceable raw water container filled with drinking water such as mineral water.

### BACKGROUND ART

In the past, water dispensers were used mainly in offices and hospitals, etc. However, since interest in the safety of water or in health is growing these days, the number of water dispensers used in ordinary homes is increasing. Such a water dispenser (as disclosed in the below-identified patent document 1) is generally known in which a replaceable raw water container is placed on the top surface of a casing, drinking water contained in the raw water container falls by gravity into a cold water tank received in the casing so as to be cooled in the cold water tank, further drinking water stored in the cold water tank falls by gravity into a hot water tank arranged at a lower level than the cold water tank so as to be heated in the hot water tank, and cold water and hot water are discharged to outside from the cold water tank and the hot water tank, respectively.

In such a water dispenser having the function to discharge hot water, normally, a hot water discharge pipe is connected to the top surface of a hot water tank so that high-temperature drinking water is discharged to outside through the hot water discharge pipe from the hot water tank, and the hot water discharge pipe has, on the side of the hot water tank, an end portion having an opening in the vicinity of the top surface of the hot water tank, thereby making it possible to discharge the upper layer portion of high-temperature drinking water fully heated by a heater attached to the hot water tank.

### PRIOR ART DOCUMENT(S)

### Patent Document(s)

Patent document 1: Japanese Unexamined Patent Application Publication No. 2013-18500 (FIG. 1)

### SUMMARY OF THE INVENTION

### Problems to be Solved by the Invention

In such a water dispenser having the function to discharge hot water as described above, when a user opens a cock attached to the outlet side of a hot water discharge pipe, due to the own weight of drinking water stored in a cold water tank, drinking water is discharged from a hot water tank through the hot water discharge pipe, and drinking water equal in amount to the discharged drinking water flows into the hot water tank from the cold water tank. Therefore, even in the arrangement in which the end portion of the hot water discharge pipe on the side of the hot water tank has an opening in the vicinity of the top surface of the hot water tank, the hot water tank is always filled with drinking water.

However, actually, when drinking water stored in the hot water tank is heated by a heater, air tends to separate from drinking water in the hot water tank as its temperature rises, and to collect in the upper portion of the hot water tank. When drinking water is discharged from the hot water tank, high-temperature air collected in the upper portion of the hot water tank tends to spout out of the hot water discharge pipe.

In a water dispenser having the function to discharge hot water, it is an object of the present invention to prevent high-temperature air from spouting out of a hot water discharge pipe when hot water is discharged.

### Means for Solving the Problems

In order to achieve the above object, the present invention provides a water dispenser comprising: a hot water tank in which high-temperature drinking water is to be stored; an upper tank which is arranged at a higher level than the hot water tank, and in which drinking water to be supplied to the hot water tank is to be stored; a hot water tank water supply pipe through which the interior of the upper tank communicates with the interior of the hot water tank such that drinking water is introduced from the upper tank into the hot water tank through the hot water tan water supply pipe due to the weight of the drinking water; a heater configured to heat drinking water in the hot water tank; and a hot water discharge pipe configured such that high-temperature thinking water stored in the hot water tank can be discharged through the hot water discharge pipe to outside, characterized in that the hot water discharge pipe has an end portion on a side of the hot water tank, wherein said end portion has an opening at a position spaced apart downwardly from a top surface of the hot water tank, wherein the hot water tank water supply pipe is provided with an in-tank pipe portion extending downwardly from the top surface of the hot water tank through the interior of the hot water tank, and wherein the in-tank pipe portion is formed, at an intermediate portion thereof, with a small hole which opens at a higher level than the opening of the end portion of the hot water discharge pipe on the side of the hot water tank.

Namely, the end portion of the hot water discharge pipe on the side of the hot water tank has an opening at a position spaced apart downwardly from the top surface of the hot water tank, and the small hole of the in-tank pipe portion of the hot water tank water supply pipe is located at a higher level than the opening of the end portion of the hot water discharge pipe on the side of the hot water tank. With this arrangement, as the temperature of drinking water rises in the hot water tank, air separating from the drinking water collects only in the portion of the hot water tank higher than the small hole of the in-tank pipe portion, and after the portion of the hot water tank higher than the small hole has been completely filled with air, any excess air which further separates from drinking water flows into the hot water tank water supply pipe through the small hole, and is then discharged into the upper tank, so that high-temperature air is never introduced into the hot water discharge pipe.

### Effects of the Invention

As described above, the water dispenser according to the present invention is configured such that air collects only in the portion of the hot water tank higher than the small hole of the in-tank pipe portion of the hot water tank water supply pipe, and air is never introduced into the hot water discharge pipe having an opening at a position lower than the small hole of the in-tank pipe portion. Therefore, when a user discharges high-temperature drinking water from the hot water tank, it is possible to reliably prevent high-temperature air from spouting out of the hot water discharge pipe.

### BRIEF DESCRIPTION OF THE DRAWINGS

FIG. 1 is a sectional view of a water dispenser according to a first embodiment of the present invention, the water dispenser being in a normal operation mode.

FIG. 2 is a sectional view of the water dispenser of FIG. 1, the water dispenser being in a sterilization operation mode.

FIG. 3 is a sectional view of a main portion of the water dispenser, the sectional view illustrating the state in which the container holder of FIG. 1 is out of a casing.

FIG. 4(a) is a sectional view of a main portion of the water dispenser, the sectional view illustrating the state in which air is collecting in the upper portion of the hot water tank of FIG. 1.

FIG. 4(b) is a sectional view of a main portion of the water dispenser, the sectional view illustrating the state in which air is collecting in the upper portion of the hot water tank of FIG. 1.

FIG. 5 is a sectional view of a water dispenser according to a second embodiment of the present invention.

### BEST MODE FOR CARRYING OUT THE INVENTION

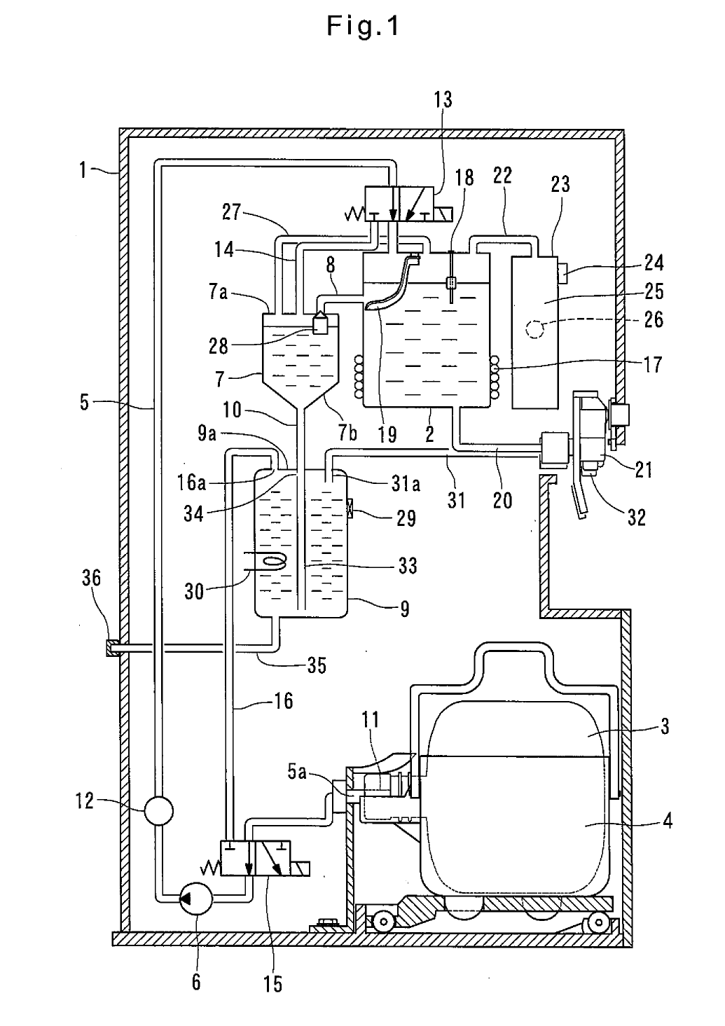

FIG. 1 illustrates a water dispenser according to the first embodiment of the present invention. This water dispenser includes a casing 1, a cold water tank 2 in which low-temperature drinking water to be discharged to the outside of the casing 1 is stored, a replaceable raw water container 3 filled with drinking water to be supplied to the cold water tank 2, a container holder 4 configured to support the raw water container 3, a raw water supply pipe 5 through which the interior of the cold water tank 2 communicates with the interior of the raw water container 3, a pump 6 attached to an intermediate portion of the raw water supply pipe 5, a buffer tank 7 arranged on one lateral side of the cold water tank 2, a buffer tank water supply pipe 8 through which drinking water is introduced into the buffer tank 7 from the cold water tank 2, a hot water tank 9 in which high-temperature drinking water to be discharged to the outside of the casing 1 is stored, and a hot water tank water supply pipe 10 through which the interior of the buffer tank 7 communicates with the interior of the hot water tank 9.

The end portion of the raw water supply pipe 5 on its upstream side is provided with a joint 5a configured to be detachably connected to a water outlet 11 of the raw water container 3. The end portion of the raw water supply pipe 5 on its downstream side is connected to the cold water tank 2. The raw water supply pipe 5 first extends downwardly from the joint 5a so as to pass through a position lower than the joint 5a, and then changes its direction so as to extend upwardly. The pump 6 is attached to the portion of the raw water supply pipe 5 lower than the joint 5a.

The pump 6 draws out drinking water from the raw water container 3 through the raw water supply pipe 5 by transferring drinking water in the raw water supply pipe from the side of the raw water container 3 toward the cold water tank 2. The pump 6 may be, for example, a diaphragm pump or a gear pump.

A flow sensor 12 is attached to the portion of the raw water supply pipe 5 on the outlet side of the pump 6. If the flow of drinking water in the raw water supply pipe 5 disappears while the pump 6 is operating, the flow sensor 12 detects this state. At this time, a container replacement lamp (not shown) provided at the front of the casing 1 is turned on so as to inform a user that the raw water container 3 now needs to be replaced by a new raw water container 3.

A first three-way valve 13 is provided at the portion of the raw water supply pipe 5 between the pump 6 and the cold water tank 2 (preferably, at the end portion of the pipe 5 on the side of the cold water tank 2). Though the first three-way valve 13 is arranged at a position away from the cold water tank 2 in the drawings, the valve 13 may be connected directly to the cold water tank 2. The first three-way valve 13 has a first sterilization pipe 14 (pipe for sterilization) connected thereto through which the first three-way valve 13 communicates with the interior of the buffer tank 7. The end portion of the first sterilization pipe 14 on the side of the buffer tank 7 is connected to the top surface 7a of the buffer tank 7.

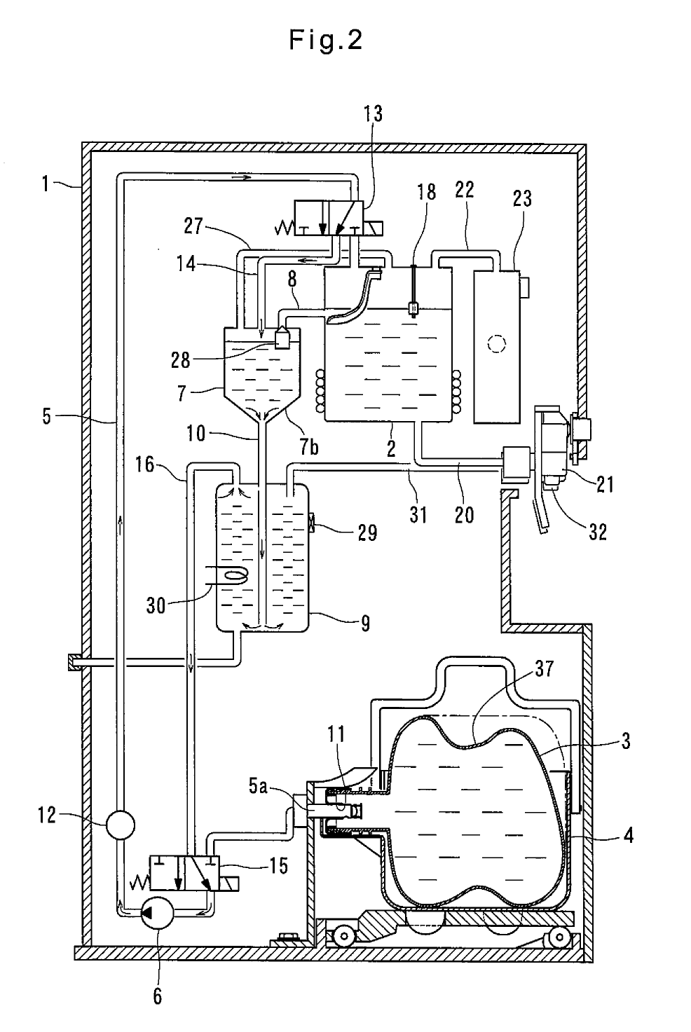

The first three-way valve 13 can switch the flow of drinking water by moving between a normal flow path position (see FIG. 1) in which the first three-way valve 13 allows communication between the pump 6 and the cold water tank 2, while blocking communication between the pump 6 and the first sterilization pipe 14, and a sterilization flow path position (see FIG. 2) in which the first three-way valve 13 allows communication between the pump 6 and the pipe 14, while blocking communication between the pump 6 and the tank 2. The first three-way valve 13 is constituted by an electromagnetic valve configured to move from the normal flow path position to the sterilization flow path position when energized, and to move from the sterilization flow path position to the normal flow path position when de-energized.

A second three-way valve 15 is provided at the portion of the raw water supply pipe 5 between the pump 6 and the raw water container 3 (preferably, at the end portion of the raw water supply pipe 5 on the side of the container 3). Though the second three-way valve 15 is arranged at a position away from the joint 5a in the drawings, the second three-way valve 15 may be connected directly to the joint 5a. The second three-way valve 15 has a second sterilization pipe 16 (pipe for sterilization) connected thereto through which the second three-way valve 15 communicates with the interior of the hot water tank 9. The end portion of the second sterilization pipe 16 on the side of the hot water tank 9 is connected to the top surface 9a of the tank 9.

The second three-way valve 15 can switch the flow of drinking water by moving between a normal flow path position (see FIG. 1) in which the valve 15 allows communication between the pump 6 and the raw water container 3, while blocking communication between the pump 6 and the second sterilization pipe 16, and a sterilization flow path position (see FIG. 2) in which the valve 15 allows communication between the pump 6 and the pipe 16, while blocking communication between the pump 6 and the container 3. The second three-way valve 15 is, as with the first three-way valve 13, constituted by an electromagnetic valve configured to move from the normal flow path position to the sterilization flow path position when energized, and to move from the sterilization flow path position to the normal flow path position when de-energized.

Each of the first three-way valve 13 and the second three-way valve 15 shown may be replaced by a three-way valve assembly constituted by a plurality of two-way valves and having the same function as the first three-way valve 13 or the second three-way valve 15.

The cold water tank 2 contains air and drinking water in two layers with the air forming the upper layer and the water forming the lower layer. The cold water tank 2 has a cooling device 17 attached thereto which cools drinking water stored in the cold water tank 2. The cooling device 17 is arranged on the outer periphery of the lower portion of the cold water tank 2, and keeps drinking water stored in the tank 2 at a low temperature (about 5 degrees Celsius).

The cold water tank 2 has a water level sensor 18 attached thereto which detects the water level of drinking water stored in the tank 2. When the water level detected by the water level sensor 18 has fallen to a predetermined level, the pump 6 is activated so that drinking water is supplied from the raw water container 3 to the cold water tank 2.

The cold water tank 2 is provided in its interior with a guiding plate 19 by which, when drinking water is supplied to the cold water tank 2 from the raw water container 3, the vertical flow of the drinking water flowing into the cold water tank 2 from the raw water supply pipe 5 is changed into a horizontal flow of drinking water. The guiding plate 19 thus prevents low-temperature drinking water stored in the lower portion of the cold water tank 2 from mixing with and being stirred by the normal-temperature drinking water flowing into the tank 2 from the raw water supply pipe 5.

The cold water tank 2 has a cold water discharge pipe 20 which is connected to the bottom surface of the tank 2 and through which low-temperature drinking water stored in the tank 2 is discharged to outside. The cold water discharge pipe 20 has a cold water cock 21 mounted thereto which is operable from the outside of the casing 1. By opening this cold water cock 21, low-temperature drinking water can be discharged from the cold water tank 2 into a cup, etc. The capacity of the cold water tank 2 (its capacity to hold drinking water) is smaller than that of the raw water container 3, and is about 2 to 4 liters.

An air sterilization chamber 23 is connected to the cold water tank 2 through an air introduction line 22. The air sterilization chamber 23 includes a hollow case 25 formed with an air intake 24, and an ozone generator 26 mounted in the case 25. The ozone generator 26 may be, for example, a low-pressure mercury lamp, or a silent electrical discharge device. The ozone generator 26 is turned on at predetermined time intervals to generate ozone so that the interior of the case 25 of the air sterilization chamber 23 is always filled with ozone.

Air is introduced through the air introduction line 22 into the cold water tank 2 as the water level in the cold water tank 2 falls so that the interior of the tank 2 is maintained at atmospheric pressure. Also at this time, since air passes through the air sterilization chamber 23 and thus is sterilized by ozone therein before being introduced into the cold water tank 2, the air in the cold water tank 2 is kept clean.

The buffer tank 7 is arranged at a higher level than the hot water tank 9, and constitutes an upper tank relative to the hot water tank 9. The buffer tank 7 contains air and drinking water in two layers with the air forming the upper layer and the water forming the lower layer. An air pipe 27 is connected to the top surface 7a of the buffet tank 7. The air layer of the buffer tank 7 communicates with the air layer of the cold water tank 2 through the air pipe 27, so that the interior of the tank 7 is maintained at atmospheric pressure.

The air layer of the buffer tank 7 communicates with the water layer of the cold water tank 2 through the buffer tank water supply pipe 8. The end portion of the buffer tank water supply pipe 8 on the side of the cold water tank 2 opens to the upper portion of the water layer in the cold water tank 2 so that drinking water constituting the upper portion of the water layer is introduced into the buffer tank water supply pipe 8 from the upper portion of the water layer of the tank 2. With this arrangement, since drinking water stored in the upper portion of the water layer in the cold water tank 2 is supplied into the buffer tank 7, it is possible to prevent low-temperature drinking water stored in the lower portion of the cold water tank 2 from flowing into the buffer tank 7, and thus to effectively keep drinking water stored in the tank 2 at a low temperature.

The end portion of the buffer tank water supply pipe 8 on the side of the buffer tank 7 is connected to the top surface 7a of the buffer tank 7, and is provided with a float valve 28 configured to open and close according to the water level in the buffer tank 7. This float valve 28 opens to allow the flow of drinking water when the water level in the buffer tank 7 has fallen below a predetermined level, and closes to block the flow of drinking water when the water level in the buffer tank 7 has reached a predetermined level.

The capacity of the buffer tank 7 (its capacity to hold drinking water) is smaller than that of the hot water tank 9, and is about 0.2 to 0.5 liters. The bottom surface 7b of the buffer tank 7 is cone-shaped such that its center is at the lowest position. The hot water tank water supply pipe 10 is connected to the center of this bottom surface 7b, and to the hot water tank 9, arranged at a lower level than the buffer tank 7.

The hot water tank 9 has a temperature sensor 29 attached thereto which detects the temperature of drinking water in the hot water tank 9, and a heater 30 attached thereto which is configured to heat drinking water in the hot water tank 9. The heater 30 is turned on and turned off according to the temperature detected by the temperature sensor 29, thereby keeping drinking water stored in the hot water tank 9 at a high temperature (about 90 degrees Celsius). Though the figures illustrate a sheath heater as the heater 30, the heater 30 may be a band heater.

The hot water tank 9 has a hot water discharge pipe 31 which is connected to the top surface 9a of the tank 9 and through which high-temperature drinking water stored in the upper portion of the tank 9 is discharged to outside. The hot water discharge pipe 31 has a hot water cock 32 mounted thereto which is operable from the outside of the casing 1. By opening this hot water cock 32, high-temperature drinking water can be discharged from the hot water tank 9 into a cup, etc. When drinking water is discharged from the hot water tank 9, drinking water stored in the buffer tank 7 is introduced, due to its own weight, into the hot water tank 9 through the hot water tank water supply pipe 10. The capacity of the hot water tank 9 (its capacity to hold drinking water) is about 1 to 2 liters.

The hot water tank water supply pipe 10 includes an in-tank pipe portion 33 extending downwardly from the top surface 9a of the hot water tank 9 through the interior of the hot water tank 9. The in-tank pipe portion 33 has a bottom end opening in the vicinity of the bottom surface of the hot water tank 9. A small hole 34 is formed in the in-tank pipe portion 33 at its portion in the vicinity of the top surface 9a of the hot water tank 9 such that the interior of the in-tank pipe portion 33 communicates with the exterior of the pipe portion 33 through the small hole 34.

The hot water discharge pipe 31 has, on the side of the hot water tank 9, an end portion 31a extending downwardly through the top surface 9a of the hot water tank 9 into the hot water tank 9 and having an opening at a position spaced apart downwardly from the top surface 9a (e.g., at a position away by about 5 to 15 mm downwardly from the top surface 9a). The small hole 34 of the in-tank pipe portion 33 opens at a position higher than the opening of the end portion 31a of the hot water discharge pipe 31 on the side of the hot water tank 9. The second sterilization pipe 16 has, on the side of the hot water tank 9, an end portion 16a having an opening at a position higher than the small hole 34 of the in-tank pipe portion 33.

A drain pipe 35 is connected to the bottom surface of the hot water tank 9 so as to extend to the exterior of the casing 1. The outlet of the drain pipe 35 is closed by a plug 36. However, an on-off valve may be used instead of the plug 36.

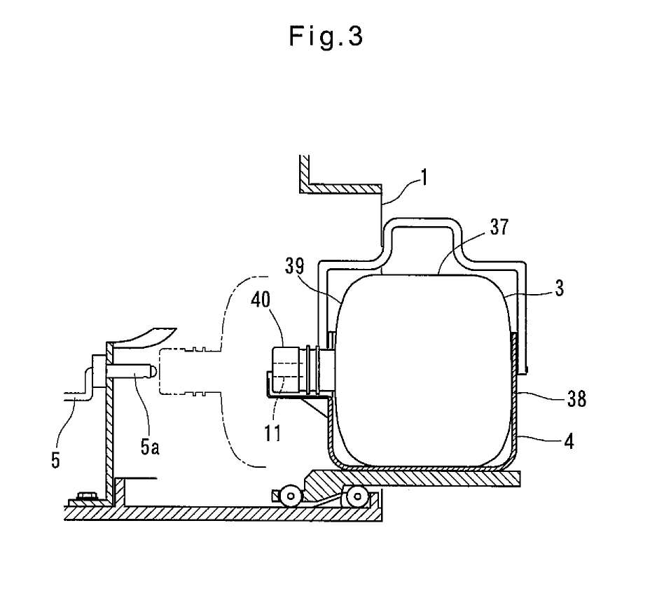

As illustrated in FIG. 3, the raw water container 3 includes a tubular hollow trunk portion 37, a bottom portion 38 connected to one end of the trunk portion 37, and a neck portion 40 connected to the other end of the trunk portion 37 through a shoulder portion 39. The water outlet 11 is formed in this neck portion 40. The trunk portion 37 of the raw water container 3 is flexibly formed so as to shrink as the amount of water remaining in the container 3 decreases. The raw water container 3 is formed by blow molding of polyethylene terephthalate (PET) resin. The maximum volume of the raw water container 3, namely, the maximum amount of drinking water the container 3 can hold, is about 10 to 20 liters.

The raw water container 3 may be constituted by a bag made of resin film and including a connector bonded to the film by heat welding and having the water outlet 11, and a box, such as a corrugated paperboard box, in which this bag is received (so-called “bag-in box”).

The container holder 4 is supported so as to be movable in a horizontal direction between the received position (position illustrated in FIG. 1) in which the raw water container 3 is received in the casing 1 and the pulled-out position (position illustrated in FIG. 3) in which the container 3 is out of the casing 1. The joint 5a is fixed in position inside of the casing 1 such that, as illustrated in FIG. 3, when the container holder 4 is moved to the pulled-out position, the water outlet 11 of the raw water container 3 is separated from the joint 5a, and such that, as illustrated in FIG. 1, when the holder 4 is moved to the received position, the water outlet 11 of the container 3 is connected to the joint 5a.

It is now described how the above water dispenser operates.

During the normal operation mode, as illustrated in FIG. 1, with the first three-way valve 13 and the second three-way valve 15 each moved to the normal flow path position, water level control is performed so as to keep the water level in the cold water tank 2 within a predetermined range, concurrently with heater control for keeping drinking water stored in the hot water tank 9 at a high temperature.

Namely, when a user operates the cold water cock 21, low-temperature drinking water stored in the cold water tank 2 is, due to its own weight, discharged to outside through the cold water discharge pipe 20, so that the amount of drinking water decreases in the tank 2. When the water level sensor 18 detects that the water level in the cold water tank 2 has fallen below a lower limit, the pump 6 is activated by the above-described water level control, so that drinking water is supplied from the raw water container 3 to the cold water tank 2 through the raw water supply pipe 5.

When a user operates the hot water cock 32, high-temperature drinking water stored in the hot water tank 9 is discharged to outside through the hot water discharge pipe 31, so that drinking water stored in the buffer tank 7 is introduced, due to its own weight, into the hot water tank 9 through the hot water tank water supply pipe 10. Drinking water stored in the buffer tank 7 functions to push drinking water stored in the hot water tank 9 to the outside of the casing 1. When drinking water stored in the buffer tank 7 is introduced into the hot water tank 9, the water level in the buffer tank 7 falls. As a result, the float valve 28 opens, allowing drinking water to be introduced into the buffer tank 7 from the upper portion of the water layer of the cold water tank 2 through the buffer tank water supply pipe 8.

When drinking water is introduced into the hot water tank 9 from the buffer tank 7, the temperature of drinking water in the hot water tank 9 falls. When the temperature of drinking water stored in the hot water tank 9, as detected by the temperature sensor 29, has fallen below a lower limit (e.g., 85 degrees Celsius) predetermined by the heater control, the heater 30 is turned on so as to heat drinking water in the tank 9.

On the other hand, during the sterilization operation mode, as illustrated in FIG. 2, the above water level control is stopped, and with the first three-way valve 13 and the second three-way valve 15 each moved to the sterilization flow path position, water circulation control by the pump 6 is performed simultaneously with the above heater control. Due to these controls, high-temperature drinking water stored in the hot water tank 9 circulates through the second sterilization pipe 16, the second three-way valve 15, the raw water supply pipe 5, the first three-way valve 13, the first sterilization pipe 14, the buffer tank 7, and the hot water tank water supply pipe 10, so that the circulation path is sterilized. At this time, since the high-temperature drinking water does not pass through the cold water tank 2, even during the sterilization operation mode, a user can discharge low-temperature drinking water from the tank 2.

When the normal operation mode is started, the hot water tank 9 is completely filled with drinking water. However, during the normal operation mode, when the drinking water in the hot water tank 9 is heated by the heater 30, and its temperature rises, air dissolved in the drinking water will separate from the drinking water in the form of air bubbles, and the air bubbles will rise in the hot water tank 9 so as to collect in the upper portion of the hot water tank 9, thereby forming an air layer therein.

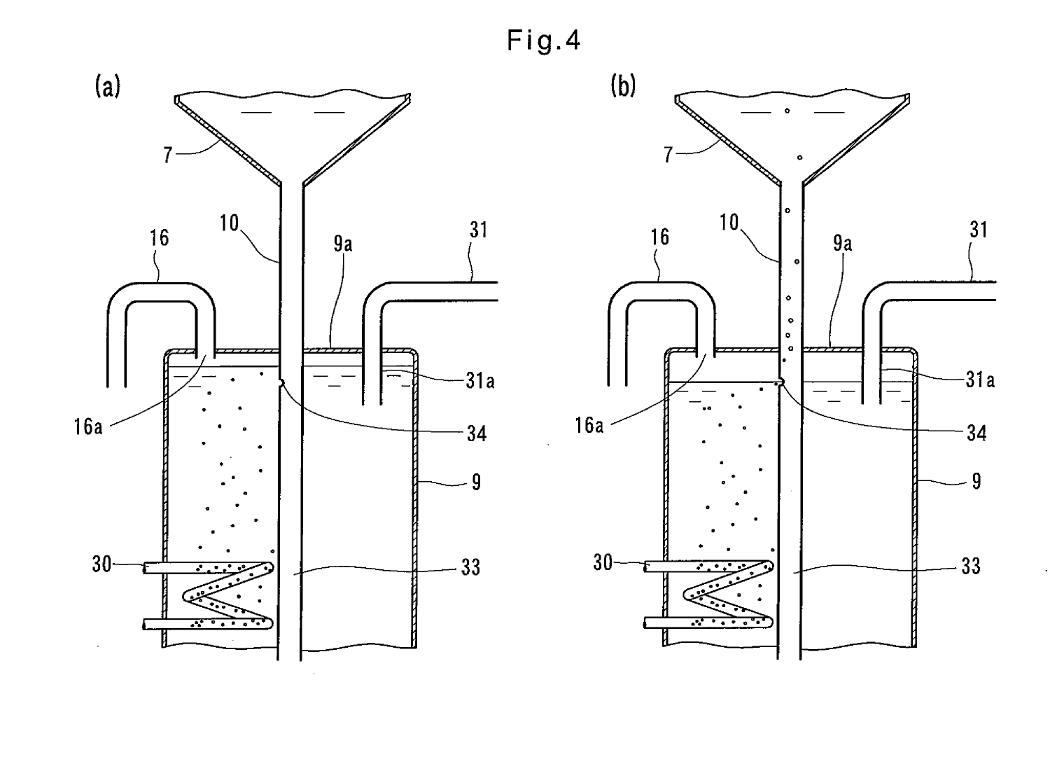

In this water dispenser, as described above, the end portion 31a of the hot water discharge pipe 31 on the side of the hot water tank 9 has an opening at a position spaced apart downwardly from the top surface 9a of the tank 9, and the small hole 34 of the in-tank pipe portion 33 of the hot water tank water supply pipe 10 is located at a higher level than this opening of the end portion 31a. With this arrangement, as illustrated in FIG. 4(a), air separating from drinking water collects in the portion of the hot water tank 9 higher than the small hole 34 of the in-tank pipe portion 33. After the portion of the hot water tank 9 higher than the small hole 34 has been completely filled with air separating from drinking water, as illustrated in FIG. 4(b), any excess air which further separates from drinking water flows into the hot water tank water supply pipe 10 through the small hole 34, and is then discharged into the buffer tank 7. This prevents air from collecting in the portion of the hot water tank 9 lower than the small hole 34, so that high-temperature air will never be introduced into the hot water discharge pipe 31, because the hot water discharge pipe 31 has an opening at a position lower than the small hole 34.

Also, during the sterilization operation mode, air that has collected in the portion of the hot water tank 9 higher than the small hole 34 is discharged through the second sterilization pipe 16, because the pipe 16 opens at a position higher than the small hole 34.

Since this water dispenser is configured as above, when a user discharges high-temperature drinking water from the hot water tank 9, it is possible to reliably prevent high-temperature air from spouting out of the hot water discharge pipe 31. Therefore, this water dispenser is safer to use than conventional water dispensers, and moreover can be used comfortably, since when a user operates the hot water cock 32, hot water is discharged with no delay.

The present invention can be applied not only to such a water dispenser as described in the above embodiment which can operate in a sterilization operation mode by use of a buffer tank, but also to, of course, a water dispenser having a general structure, namely, a water dispenser having no sterilization operation mode (function) and in which the cold water tank constitutes an upper tank which stores drinking water to be supplied to the hot water tank.

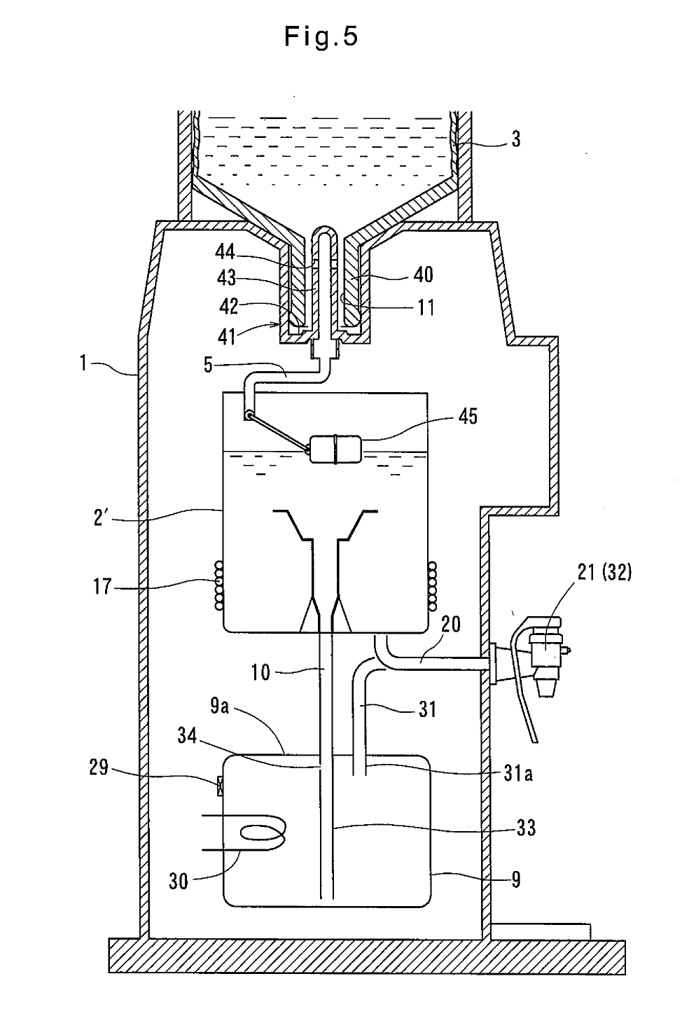

FIG. 5 illustrates another embodiment (second embodiment), in which the present invention is applied to a water dispenser having the general structure as described above. Its members having the same functions as those of the water dispenser of the first embodiment are denoted by the same reference numerals to simplify their description. The water dispenser of the second embodiment includes a container connecting portion 41 which is provided on the top surface of a casing 1 and to which a water outlet 11 of a raw water container 3 directed downwardly is configured to be connected, a cold water tank (upper tank) 2′ provided at a lower level than the container connecting portion 41 and connected to the container connecting portion 41 through a raw water supply pipe 5, and a hot water tank 9 provided at a lower level than the cold water tank 2′ and connected to the cold water tank 2′ through a hot water tank water supply pipe 10. This water dispenser further includes a cold water cock 21 mounted to a cold water discharge pipe 20 connected to the bottom surface of the cold water tank 2′, and a hot water cock 32 mounted to a hot water discharge pipe 31 connected to the top surface 9a of the hot water tank 9.

The container connecting portion 41 of the casing 1 includes a recess 42 into which the neck portion 40 of the raw water container 3 is configured to be fitted, and a tubular protrusion 43 (corresponding to the joint 5a in the first embodiment) protruding from the center of the recess 42 and configured to be inserted into the water outlet 11 of the raw water container 3. A water intake hole 44 is formed in the tubular protrusion 43.

A float valve 45 is provided inside of the cold water tank 2′. When the float valve 45 is actuated due to the fall of the water level in the cold water tank 2′, drinking water is supplied to the cold water tank 2′ from the raw water container 3 through the raw water supply pipe 5. An air introduction line (not shown) is connected to the top surface of the cold water tank 2′ so that, as the water level in the cold water tank 2′ falls, sterilized air is introduced into the cold water tank 2′ from an air chamber (not shown) through the air introduction line. The hot water tank water supply pipe 10 has a top end opening located in the cold water tank 2′ at a position higher than a cooling device 17 provided on the outer periphery of the lower portion of the tank 2′, whereby cold water cooled by the cooling device 17 and collecting in the bottom portion of the cold water tank 2′ is discharged through the cold water discharge pipe 20, while relatively warm drinking water is supplied to the hot water tank 9 from the cold water tank 2′ through the hot water tank water supply pipe 10.

The hot water tank 9 of the second embodiment is substantially the same in structure as that of the first embodiment. Namely, the hot water tank 9 includes a temperature sensor 29 and a heater 30, and when hot water heated by the heater 30 is discharged from the hot water tank 9, drinking water stored in the cold water tank 2′ is introduced, due to its own weight, into the hot water tank 9 through the hot water tank water supply pipe 10. The hot water tank water supply pipe 10 includes an in-tank pipe portion 33 extending downwardly from the top surface 9a of the hot water tank 9, and having an end opening in the vicinity of the bottom surface of the hot water tank 9. A small hole 34 is formed in the portion of the in-tank pipe portion 33 close to the top surface 9a of the hot water tank 9. The hot water discharge pipe 31 has an end portion 31a extending downwardly through the top surface 9a of the hot water tank 9 into the hot water tank 9, and having an opening at a position lower than the small hole 34 of the in-tank pipe portion 33.

The water dispenser of the second embodiment is configured as described above. As in the water dispenser of the first embodiment, in the water dispenser of the second embodiment, air separating from drinking water in the hot water tank 9 as its temperature rises collects only in the portion of the hot water tank 9 higher than the small hole 34 of the in-tank pipe portion 33. After the portion of the hot water tank 9 higher than the small hole 34 has been completely filled with air, air which further separates from drinking water flows into the hot water tank water supply pipe 10 through the small hole 34, and is then discharged into the cold water tank 2′, as an upper tank, so that high-temperature air is never introduced into the hot water discharge pipe 31. Therefore, it is possible to reliably prevent high-temperature air from spouting out of the hot water discharge pipe 31 when hot water is discharged from the hot water tank 9, and thus to use the water dispenser comfortably and safely.

### DESCRIPTION OF REFERENCE NUMERALS

2: cold water tank
2′: cold water tank (upper tank)
3: raw water container
5: raw water supply pipe
6: pump
7: buffer tank (upper tank)
8: buffer tank water supply pipe
9: hot water tank
9a: top surface
10: hot water tank water supply pipe
30: heater
31: hot water discharge pipe
31a: end portion
33: in-tank pipe portion
34: small hole

1. A water dispenser comprising:
a hot water tank in which high-temperature drinking water is to be stored;
an upper tank which is arranged at a higher level than the hot water tank, and in which drinking water to be supplied to the hot water tank is to be stored;
a hot water tank water supply pipe through which an interior of the upper tank communicates with an interior of the hot water tank such that drinking water is introduced from the upper tank into the hot water tank through the hot water tank water supply pipe due to a weight of the drinking water;
a heater configured to heat drinking water in the hot water tank; and
a hot water discharge pipe configured such that high-temperature drinking water stored in the hot water tank can be discharged through the hot water discharge pipe to outside,
wherein the hot water discharge pipe has an end portion on a side of the hot water tank,
wherein said end portion has an opening at a position spaced apart downwardly from a top surface of the hot water tank,
wherein the hot water tank water supply pipe is provided with an in-tank pipe portion extending downwardly from the top surface of the hot water tank through the interior of the hot water tank, and
wherein the in-tank pipe portion is formed, at an intermediate portion thereof, with a small hole which opens at a higher level than the opening of the end portion of the hot water discharge pipe on the side of the hot water tank.
